(19) United States
(12) Patent Application Publication
(10) Pub. No.: US 2023/0252988 A1
(43) Pub. Date: Aug. 10, 2023

(54) METHOD FOR RESPONDING TO VOICE INPUT AND ELECTRONIC DEVICE SUPPORTING SAME

(71) Applicant: Samsung Electronics Co., Ltd., Gyeonggi-do (KR)

(72) Inventors: Suneung PARK, Gyeonggi-do (KR); Duseok KIM, Gyeonggi-do (KR); Sanghee KIM, Gyeonggi-do (KR); Jaeyung YEO, Gyeonggi-do (KR)

(21) Appl. No.: 18/134,878

(22) Filed: Apr. 14, 2023

Related U.S. Application Data
(63) Continuation of application No. PCT/KR2021/019750, filed on Dec. 23, 2021.

(30) Foreign Application Priority Data
Dec. 30, 2020 (KR) 10-2020-0188030

(51) Int. Cl. G10L 15/22; G10L 15/08; G10L 15/26

(52) U.S. Cl. CPC G10L 15/22; G10L 15/08; G10L 15/26

(57) ABSTRACT

A method for responding to a voice input and an electronic device for performing the method are provided. The electronic device includes a microphone, a speaker, a memory, and a processor. The processor is configured to identify first information based on a first voice input received through the microphone, output, through the speaker, a first signal for confirming whether second information related to the first information is to be output, receive, through the microphone, a second voice input related to whether the second information is to be output, store, in the memory, an indication as to whether the second information is to be output, based on the second voice input, receive a third voice input through the microphone, output, through the speaker, when the first information is identified, a second signal corresponding to the first information, based on the third voice input, and determine whether a third signal corresponding to the second information is to be output based on the stored indication as to whether the second information is to be output.

### CROSS-REFERENCE TO RELATED APPLICATION(S)

This application is a bypass continuation of International Application No. PCT/KR2021/019750, which was filed on Dec. 23, 2021, and is based on and claims priority under 35 U.S.C. § 119 to Korean Patent Application No. 10-2020-0188030, which was filed in the Korean Intellectual Property Office on Dec. 30, 2020, the entire disclosure of each of which is incorporated herein by reference.

### BACKGROUND

### 1. Field

The disclosure relates generally to a method for responding to a voice input and an electronic device supporting the same.

### 2. Description of Related Art

An electronic device, such as an artificial intelligence (AI) speaker may recognize a voice command and perform an action, such as provide requested information, corresponding thereto. For example, when the AI speaker receives a voice input “Tell me about a nearby restaurant” from a user, the AI speaker may audibly and/or visually output basic information related to a nearby restaurant (e.g., restaurant name).

The AI speaker may also provide additional information in response to the voice command, such as “It is 1 km from the user's location to the location of restaurant A.”

However, after providing the basic information, the AI speaker should request another input from the user related to whether to provide the additional information, or is forced to automatically provide (or omit) the additional information regardless of the user's desire to receive the additional information.

### SUMMARY

Accordingly, an aspect of the disclosure is to provide a method for responding to a voice input with basic information and additional information based on a user preference, and an electronic device supporting the same.

In accordance with an aspect of the disclosure, an electronic device is provided, which includes a microphone; a speaker; a memory; and a processor configured to identify first information based on a first voice input received through the microphone, output, through the speaker, a first signal for confirming whether second information related to the first information is to be output, receive, through the microphone, a second voice input related to whether the second information is to be output, store, in the memory, an indication as to whether the second information is to be output, based on the second voice input, receive a third voice input through the microphone, output, through the speaker, when the first information is identified, a second signal corresponding to the first information, based on the third voice input, and determine whether a third signal corresponding to the second information is to be output based on the stored indication as to whether the second information is to be output.

In accordance with another aspect of the disclosure, a method is provided, which includes identifying first information based on a first voice input received through a microphone; outputting, through a speaker, a first signal for confirming whether second information related to the first information is to be output; receiving, through the microphone, a second voice input related to whether the second information is to be output; storing, in a memory, an indication as to whether the second information is to be output based on the second voice input; receiving a third voice input through the microphone; outputting, when the first information is identified, a second signal corresponding to the first information based on the third voice input; and determining whether a third signal corresponding to the second information to be is output based on the stored indication as to whether the second information is to be output.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an electronic device in a network environment according to an embodiment;

FIG. 2 illustrates an electronic device according to an embodiment;

FIG. 3 illustrates a system for determining a user preference of an electronic device according to an embodiment;

FIG. 4A illustrates an operation for analyzing a user preference of an electronic device according to an embodiment;

FIG. 4B illustrates an operation for responding to a voice input according to an analyzed user preference of an electronic device according to an embodiment;

FIG. 5A illustrates an operation for analyzing a user preference of an electronic device according to an embodiment;

FIG. 5B illustrates an operation for responding to a voice input according to an analyzed user preference of an electronic device according to an embodiment;

FIG. 6 illustrates an operation for analyzing a user preference of an electronic device according to an embodiment; and

FIG. 7 is a flowchart illustrating a method for responding to a voice input according to a user preference of an electronic device according to an embodiment.

### DETAILED DESCRIPTION

Hereinafter, various embodiments of the disclosure will be described with reference to the accompanying drawings. However, the description of these embodiments is not intended to limit the disclosure to specific embodiments, and should be understood to include various modifications, equivalents, and/or alternatives to the embodiments of the disclosure.

In relation to the description of the drawings, the same reference numerals may be assigned to the same or corresponding components.

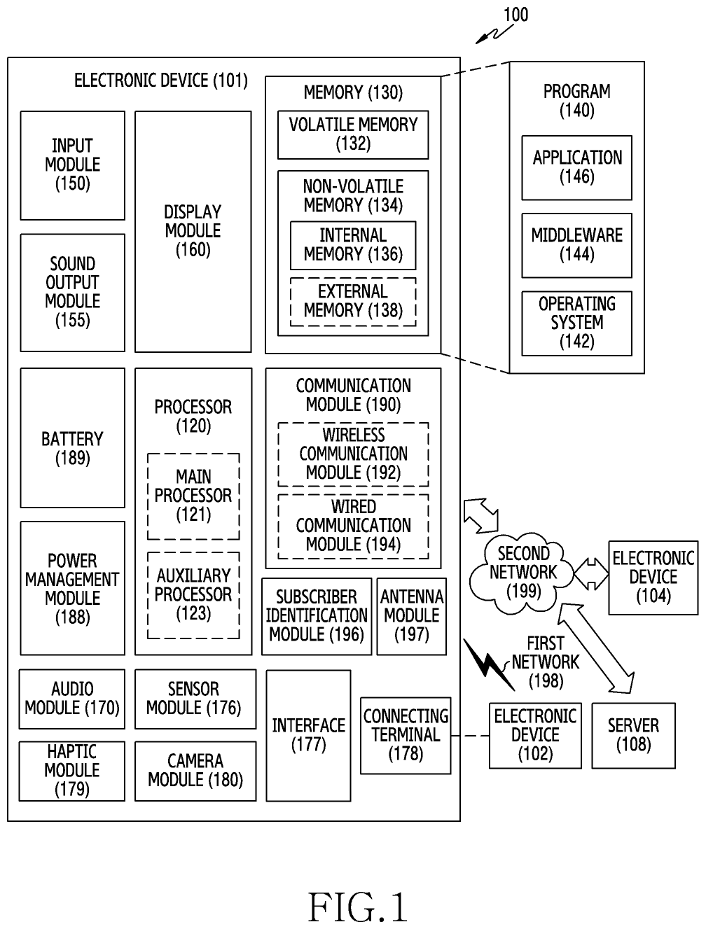

FIG. 1 illustrates an electronic device 101 in a network environment 100 according to an embodiment.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 323 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the NPU) may include a hardware structure specified for AI model processing. An AI model may be generated by machine learning. Such learning may be performed, e.g., by the electronic device 101 where the AI is performed or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent DNN (BRDNN), a deep Q-network or a combination of two or more thereof, but is not limited thereto. The AI model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or IR data association (IrDA)) or the second network 199 (e.g., a long-range communication network, such as a legacy cellular network, a 5^{th} generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4^{th} generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or MEC. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

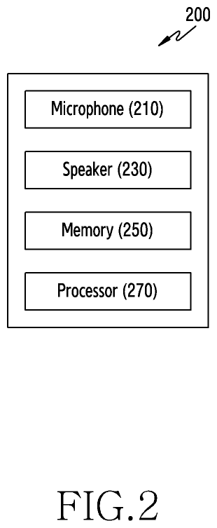

FIG. 2 illustrates an electronic device according to an embodiment.

Referring to FIG. 2, an electronic device 200 may provide basic information and additional information according to a voice command intent based on a user preference. More specifically, after providing basic information corresponding to a voice command received from a user, the electronic device 200 may provide additional information related to the basic information based on a user preference. For example, when receiving a voice input of “Find a nearby restaurant” from the user, the electronic device 200 may provide basic information “There is a restaurant A near the user”, and may provide additional information “The distance from the location of the user to the location of Restaurant A is 1 km” based on a user preference. Accordingly, when receiving the voice command from the user, the electronic device 200 may selectively provide the additional information according to the user preference.

The electronic device 200 includes a microphone 210, a speaker 230, a memory 250, and a processor 270. However, the components of the electronic device 200 are not limited thereto. Alternatively, the electronic device 200 may omit one of the above-described components and/or may include at least one additional component. For example, the electronic device 200 may further include a communication module.

The microphone 210 may receive a voice input (e.g., an input spoken by a user). The microphone 210 may be activated to an operable state in response a user input through a button disposed in one area (e.g., a housing) of the electronic device 200, or the microphone 210 may always be activated (e.g., always on) to receive a voice input. At least a portion of the microphone 210 may be exposed to the outside of the electronic device 200 to efficiently receive a voice input.

The speaker 230 may output audible information. In response to receiving a voice input through the microphone 210, the speaker 230 may audibly output data stored in the memory 250 or data transmitted from an intelligent server to the electronic device 200. For example, the speaker 230 may audibly output basic information and/or additional information for responding to the voice input received through the microphone 210. At least a portion of the speaker 230 may be exposed to the outside of the electronic device 200 to efficiently output sound.

The data stored in the memory 250 transmitted from an intelligent server to the electronic device 200 may include at least one syllable, a word including the at least one syllable, and/or a sentence including the word. The data may be audibly output through the speaker 230 as a voice signal related to a received voice input.

At least one piece of basic information (e.g., first information) for responding to a voice input may be stored in the memory 250 in the form of data. The basic information may be direct information for responding to a voice input. For example, when a voice input includes asks for the name of a restaurant, the basic information may include the name of the restaurant.

At least one piece of additional information (e.g., second information) related to the basic information may also be stored in the memory 250 in the form of data. The additional information may be indirectly related to the basic information. For example, when the basic information is information relates to the name of a restaurant, the additional information may include a distance from the current location of the electronic device 200 to the location of the restaurant. The additional information may be stored in the memory 250 in a form for allowing the user of the electronic device 200 to determine whether the additional information is to be provided (e.g., as a prompt). For example, additional information in the form of prompt may be output through the speaker 230 based on a user preference, e.g., a predesignated configuration.

Configuration information related to whether additional information is to be provided may be stored in the memory 250. The configuration information may be, when a voice input is received, a configuration related to an output of a signal for confirming whether the additional information is provided. For example, the configuration information may include a designated condition or a designated probability for selecting whether to output a signal for confirming whether the additional information is to be provided. As another example, the configuration information may include a designated weight applied to whether to output the additional information. The designated weight may be changed according to preference information.

The preference information related to whether the additional information is to be provided may be stored in the memory 250. The preference information may be, when a voice input is received, data for providing the additional information based on the voice input, without first confirming whether the additional information is to be provided. The preference information may be updated based on a voice input corresponding to an output of the signal for confirming whether the additional information is to be provided.

The processor 270 may output, in response to a voice input (e.g., a first voice input) received through the microphone 210, a signal for confirming whether additional information is to be provided, based on the configuration information. For example, the processor 270 may determine whether to output the signal for confirming whether the additional information is to be provided based on at least one of the designated condition, the designated probability, or the designated weight included in the configuration information. In response, the processor 270 may receive a voice input (e.g., a second voice input) related to the signal for confirming whether the additional information is to be provided through the microphone 210 in order to update the preference information.

In response to receiving a voice input (e.g., a third voice input) through the microphone 210, the processor 270 may determine whether the additional information is to be provided based on the updated preference information. For example, when outputting the basic information through the speaker 230 to respond to the voice input, the processor 270 may determine whether the additional information is to be provided based on the preference information related to the basic information.

The electronic device 200 may also respond to the voice input by an operation processed from an intelligent server connected through a network. For example, when receiving a voice input through the microphone 210, the electronic device 200 may transmit the received voice input to the intelligent server, through the network, and may then receive data (e.g., basic information and/or additional information for responding to the voice input) processed by the intelligent server through the network. Thereafter, the electronic device 200 may audibly output the received data through the speaker 230.

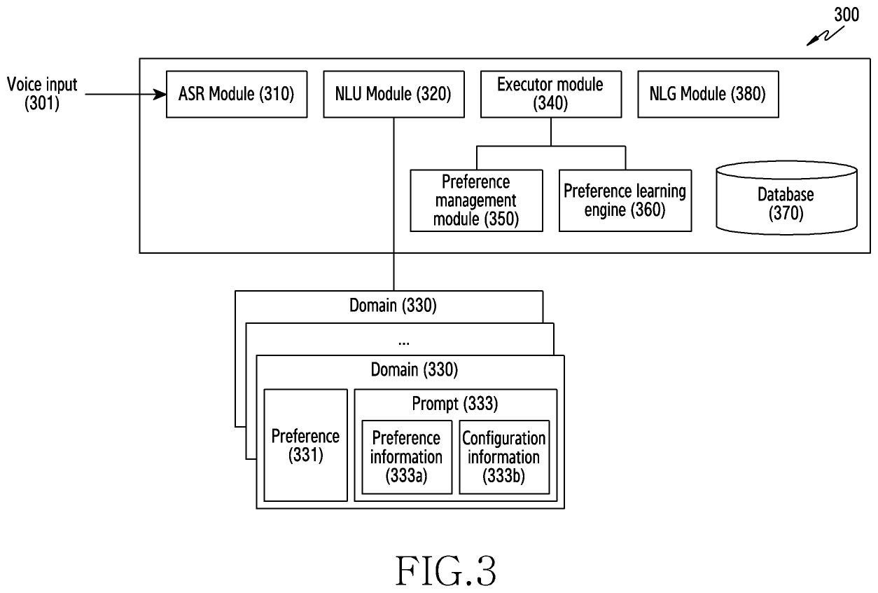

FIG. 3 illustrates a system for determining a user preference of an electronic device according to an embodiment.

Referring to FIG. 3, an electronic device 300 may provide basic information and additional information in response to a voice command, based on a user preference. For example, after providing basic information corresponding to a voice input 301 received from a user, the electronic device 300 may further provide additional information related to the basic information based on a user preference.

The electronic device 300 includes an automatic speech recognition (ASR) module 310, a natural language understanding (NLU) module 320, a domain 330, an executor module 340, a preference management module 350, a preference learning engine 360, a database 370, and a natural language generator (NLG) module 380. However, the components of the electronic device 300 are not limited thereto. Alternatively, the electronic device 300 may omit one of the above-described components and/or include at least one additional component. For example, the electronic device 300 may further include a microphone and a speaker.

The ASR module 310 may recognize the voice input 301 and convert the recognized voice input into text data. For example, the ASR module 310 may convert the voice input 301 into text data by using an acoustic model including at least one voice data related to the voice input 301 or a language model including combination information of phonemes.

The NLU module 320 may derive the intent of the voice input 301 based on the text data converted by the ASR module 310. For example, the NLU module 320 may divide the text data into grammatical units (e.g., words, phrases, or morphemes), and may analyze grammatical elements or linguistic characteristics for each unit to confirm the meaning of the converted text data, thereby deriving the intent of the voice input 301. The NLU module 320 may determine basic information for responding to the derived intent of the voice input 301 based on the derived intent of the voice input 301. The NLU module 320 may select at least one domain 330 from a plurality of domains 330 in order to determine additional information related to the basic information. The ASR module 310 and the NLU module 320 may be independent of each other as illustrated in FIG. 3, or at least a part thereof may be integrated.

A prompt 333 may be stored in the domain 330 to correspond to established preference 331. For example, when the preference 331 of the domain 330 includes a place-related attribute, the prompt 333 may include data (e.g., an instruction message) for confirming whether indirect information derivable through a corresponding place is to be provided. The prompt 333 may include preference information 333a and configuration information 333b. The preference information 333a may be provided based on the configuration information 333b. For example, when the basic information for responding to the intent of the voice input 301 relates to a corresponding place, based on at least one of a designated condition, a designated probability, or a designated weight with respect to distance information from the electronic device 300 to the place, it is possible to determine whether to output a signal for confirming whether the distance information is to be provided. The designated condition may be a condition for outputting the signal for confirming whether the distance information is provided only for a first received voice input 301 when a plurality of voice inputs 301 having the same (or similar) intent is received. The designated probability may be an output probability of a signal for confirming whether each of a plurality of pieces of preference information 333a is provided. The designated weight may be a value for correcting the designated probability based on the preference information. The plurality of domains 330 may be configured, and may be divided to include different prompts 333 according to each preference 331.

The domain 330 may be stored as a capsule corresponding to the corresponding domain 330. The capsule is a unit of a designated type of service (e.g., a Bixby service), and may be at least one service provider (or content provider) for performing a function of the domain 330 corresponding to the capsule.

The executor module 340 may execute an operation defined in the domain 330 based on the received voice input 301. The executor module 340 may receive the preference information 333a related to the intent derived from the voice input 301 through the preference management module 350 and may audibly output the received preference information 333a through the speaker 230. In response to receiving the voice input 301 related to the signal for confirming whether the preference information 333a is to be provided, the executor module 340 may provide the received voice input 301 to the preference management module 350. The executor module 340 may receive, through the preference learning engine 360, the preference information updated based on the voice input 301 related to the signal confirming whether the preference information 333a is provided, may omit the output of the signal confirming whether the preference information 333a is to be provided, and may output additional information (e.g., distance information) related to the basic information through the speaker 230.

The preference management module 350 may determine whether to confirm which preference information 333a among the plurality of pieces of preference information 333a is provided. The preference management module 350 may determine whether to provide at least one piece of preference information 333a of the plurality of pieces of preference information 333a based on the designated condition, the designated probability, or the designated weight included in the configuration information 333b. The preference management module 350 may determine the user's preference by receiving the voice input 301 related to whether the determined preference information 333a is provided. For example, when deriving a positive intent (e.g., “Yes”) from the voice input 301 related to whether the determined preference information 333a is provided, the preference management module 350 may update the determined preference information 333a to the user's preference information. However, when deriving a negative intent (e.g., “No” or no response) from the voice input 301 related to whether the determined preference information 333a is provided, the preference management module 350 may update the determined preference information 333a to the user's preference information.

The preference learning engine 360 may update the user preference information based on the voice input 301 for whether the additional information provided from the preference management module 350 is to be output. For example, the preference learning engine 360 may receive the intent of the voice input 301 for whether at least one piece of preference information 333a of the plurality of pieces of preference information 333a is provided, from the preference management module 350, and may reflect the received intent in the preference information. The preference learning engine 360 may correct the configuration information 333b based on the preference information. The preference learning engine 360 may change a configuration value of the designated condition, the designated probability, or the designated weight included in the configuration information 333b. The preference learning engine 360 may store the preference information in the database 370.

The user preference information may be stored in the database 370. For example, the preference information provided from the preference learning engine 360 may be stored in the database 370 for each user. The preference information may be stored in the database 370 for each similar user group (or for all user groups). The preference information may be applied to a user group providing the voice input 301 having the same (or similar) intent as that of the voice input 301 used to update the preference information.

The NLG module 380 may change designated information into a text form. The information changed to the text form may be in the form of natural language. The NLG module 380 may convert complex information including basic information related to the intent of the voice input 301 determined using the NLU module 320 and additional information related to the basic information into a text format corresponding to the type of natural language.

Alternatively, the ASR module 310, the NLU module 320, the domain 330, the executor module 340, the preference management module 350, the preference learning engine 360, and the database 370 may be integrated as one processor in the electronic device 300.

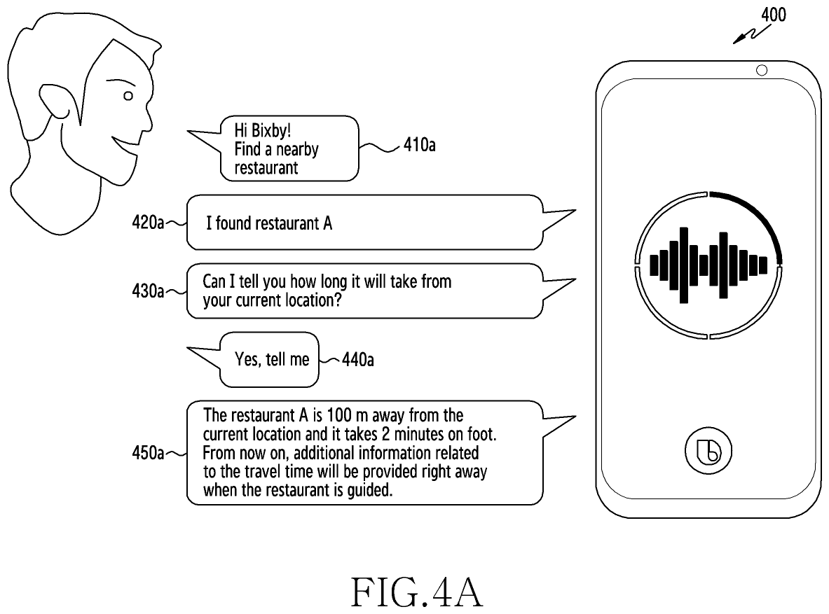

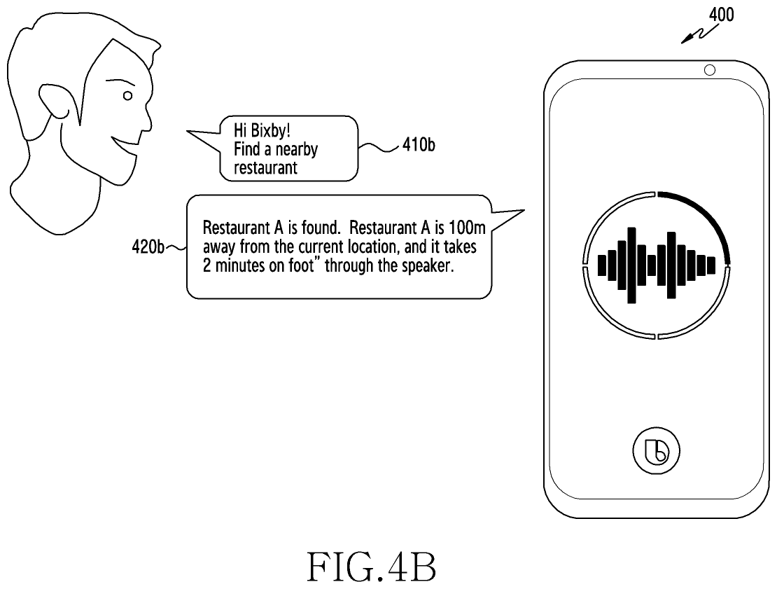

FIG. 4A illustrates an operation for analyzing a user preference of an electronic device according to an embodiment.

Referring to FIG. 4A, an electronic device 400 may determine user preference information based on voice inputs 410a and 440a.

The electronic device 400 may receive, from the user, through a microphone, a first voice input 410a requesting basic information. For example, the electronic device 400 receives the first voice input 410a “Hi Bixby! Find a nearby restaurant”.

The electronic device 400 may output, through the speaker, first information 420a identified based on the received first voice input 410a. For example, the electronic device 400 outputs the first information 420a “I found restaurant A”.

The electronic device 400 may output voice data 430a for confirming whether second information 450a derived from the first information 420a is output through the speaker. For example, the electronic device 400 outputs the voice data 430a “Can I tell you how long it will take to get to Restaurant A from your current location?”

The electronic device 400 may receive, through the microphone, from the user, a second voice input 440a related to whether the second information 450a is to be output. For example, the electronic device 400 receives the second voice input 440a “Yes, tell me”.

The electronic device 400 may update the user preference information based on the second voice input 440a related to whether the second information 450a is to be output. The electronic device 400 may change a configuration related to the output of the voice data 430a for confirming whether the second information 450a is to be provided, based on the updated preference information. Based on the updated preference information, the electronic device 400 may omit the output of the voice data 430a for confirming whether the second information 450a is output in a next conversation, and may provide the second information 450a together with the first information 420a.

The electronic device 400 may output the second information 450a through the speaker based on the second voice input 440a. For example, the electronic device 400 outputs the second information 450a “The restaurant A is 100 m away from the current location and it takes 2 minutes on foot”. When the second information 450a is provided, the electronic device 400 may inform that the user preference information has been updated. For example, the electronic device 400 outputs, through the speaker, “From now on, additional information related to the travel time will be provided right away when the restaurant is guided”.

FIG. 4B illustrates an operation for responding to a voice input according to an analyzed user preference of an electronic device according to an embodiment.

Referring to FIG. 4B, the electronic device 400 may determine whether to provide additional information based on user preference information.

The electronic device 400 may receive, from the user, through a microphone, a first voice input 410b requesting basic information. For example, the electronic device 400 receives the first voice input 410b “Hi Bixby! Find a nearby restaurant”.

When the user preference information (e.g., a positive preference) related to the received first voice input 410b exists, the electronic device 400 may output, through a speaker, complex information 420b including first information identified based on the received first voice input 410b and second information derived from the first information 420a. For example, the electronic device 400 outputs the complex information 420b “Restaurant A is found. Restaurant A is 100 m away from the current location, and it takes 2 minutes on foot”.

When another second information derivable from the first information 420a is identified, the electronic device 400 may output, through the speaker, data for confirming whether the other second information is to be output.

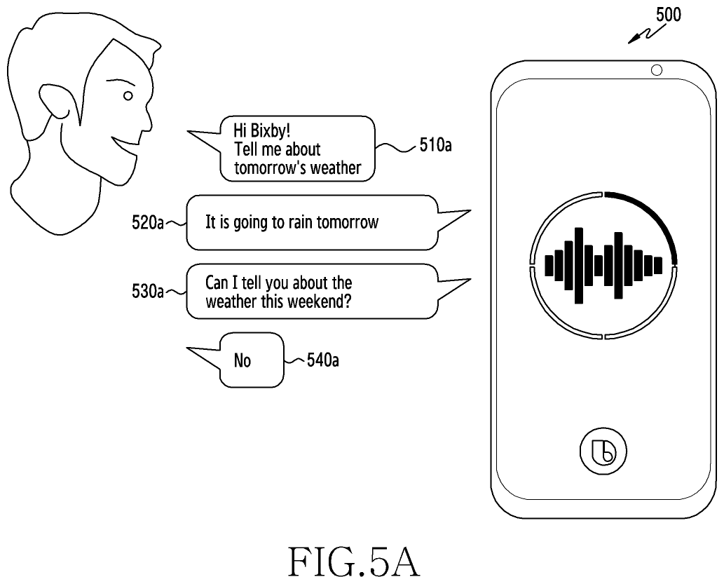

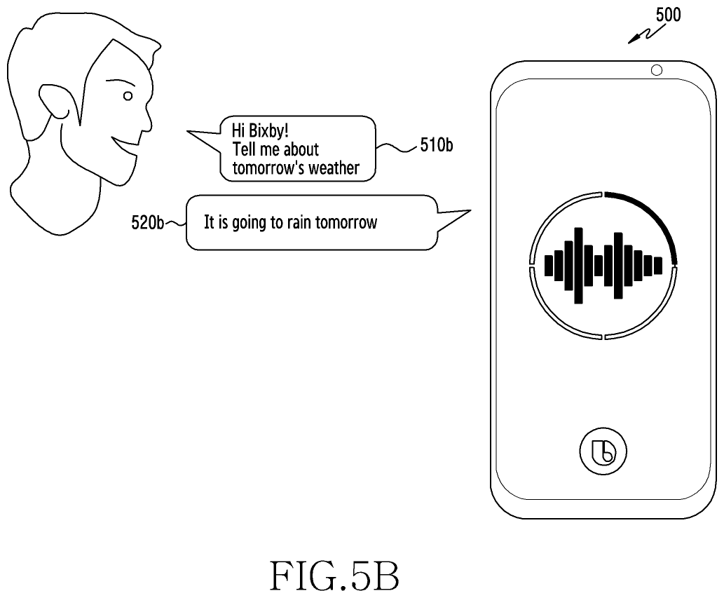

FIG. 5A illustrates an operation for analyzing a user preference of an electronic device according to an embodiment.

Referring to FIG. 5A, an electronic device 500 may determine user preference information based on user voice inputs 510a and 540a.

More specifically, the electronic device 500 may receive, from the user, through a microphone, the first voice input 510a requesting basic information (. For example, the electronic device 500 receives the first voice input 510a “Hi Bixby! Tell me about tomorrow's weather”.

The electronic device 500 may output, through a speaker, first information 520a identified based on the received first voice input 510a. For example, the electronic device 500 outputs the first information 520a “It is going to rain tomorrow”.

The electronic device 500 may audibly output, through the speaker, data 530a for confirming whether second information derived from the first information 520a is to be output. For example, the electronic device 500 outputs the data 530a “Can I tell you about the weather this weekend?”

The electronic device 500 may receive, from the user, through the microphone, a second voice input 540a related to whether the second information is to be output. For example, the electronic device 500 may receive the second voice input 540a “No”.

The electronic device 500 may update the user preference information based on the second voice input 540a related to whether the second information is to be output. The electronic device 500 may change a configuration related to the output of the data 530a for confirming whether the second information is to be output, based on the updated preference information. The electronic device 500 may omit the output of the voice data 530a for confirming whether the second information is to be output in the next conversation based on the updated preference information, and may provide only the first information 520a.

FIG. 5B illustrates an operation for responding to a voice input according to an analyzed user preference of an electronic device according to an embodiment.

Referring to FIG. 5B, the electronic device 500 (may determine whether to provide additional information based on user preference information.

More specifically, the electronic device 500 may receive, from the user, through a microphone, a first voice input 510b requesting basic information. For example, the electronic device 500 receives the first voice input 510b “Hi Bixby! Tell me about tomorrow's weather”.

When there is user preference information (e.g., a negative preference) related to the received first voice input 510b, the electronic device 500 may output, through a speaker, first information 520b identified based on the received first voice input 510b. For example, the electronic device 400 outputs only the first information 520b “It is going to rain tomorrow”.

When another second information derivable from the first information 520b is identified, the electronic device 500 may audibly output, through the speaker, data for confirming whether the other second information is to be output, after or before outputting the first information 520b.

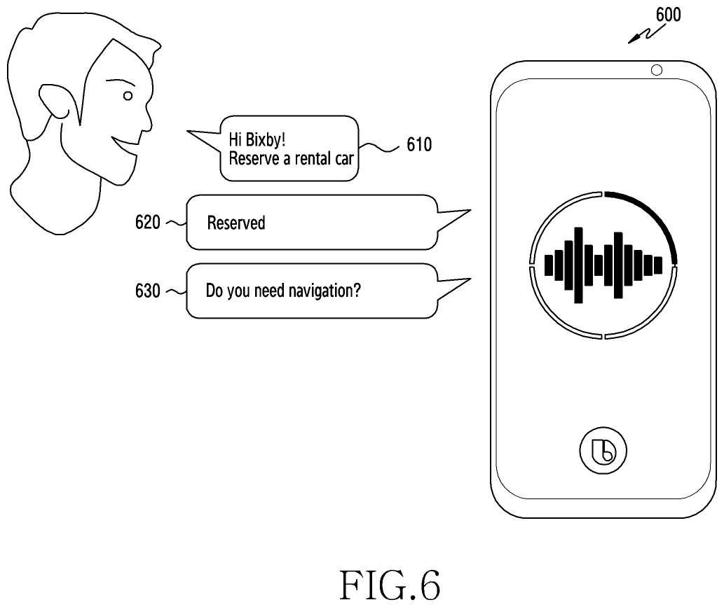

FIG. 6 illustrates an operation for analyzing a user preference of an electronic device according to an embodiment.

Referring to FIG. 6, an electronic device 600 may generate additional information for determining user preference information based on a voice input 610.

More specifically, the electronic device 600 may receive, from the user, through a microphone, a first voice input 610 requesting to perform a designated operation. For example, the electronic device 600 receives the first voice input 610 “Hi Bixby! Reserve a rental car”.

The electronic device 600 may execute a designated operation based on the received first voice input 610, and may output, through a speaker, first information 620 related to the execution result. For example, the electronic device 600 outputs the first information 620 “Reserved”.

When the received first voice input 610 is an input requesting to perform a designated operation, the electronic device 600 may generate second information from the first voice input 610 and may output, through the speaker, data 630 for confirming whether the generated second information is to be output. For example, the electronic device 600 outputs the data 630 “Do you need navigation?”

The electronic device 600 may receive, from the user, through the microphone, a second voice input related to whether the second information is to be output. For example, the electronic device 600 receives a second voice input “Yes, tell me” or “No”. In addition, the electronic device 600 may update the user preference information based on the second voice input related to whether the second information is to be output.

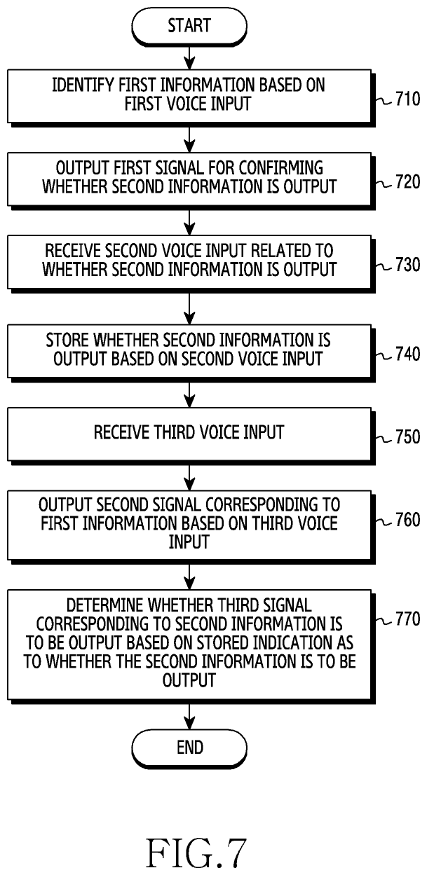

FIG. 7 is a flowchart illustrating a method for responding to a voice input according to a user preference of an electronic device according to an embodiment.

Referring to FIG. 7, in step 710, the electronic device identifies first information (e.g., basic information) based on a first voice input from a user. For example, when receiving the first voice input of “Find a nearby restaurant” through a microphone, the electronic device may identify first information including the name (e.g., restaurant A) of a restaurant located near the user.

In step 720, the electronic device outputs a first signal for confirming whether second information (e.g., additional information) related to the first information is to be output. For example, the electronic device may output “Can I tell you how long it will take to get to Restaurant A from your current location?” through a speaker. The first signal may include, for example, at least a part of the second information derived from the first information. The electronic device may determine whether to output the first signal based on configuration information including at least one of a designated condition, a designated probability, or a designated weight.

In step 730, the electronic device receives a second voice input for responding to the first signal related to whether the second information is to be output. For example, the electronic device may receive “Yes, tell me” or “No” through the microphone, in response to “Can I tell you how long it will take to get to Restaurant A from your current location?”

In step 740, based on the second voice input, the electronic device stores, in a memory, an indication as to whether the second information is to be output (e.g., a user preference). For example, the electronic device may update the preference information stored in the memory based on whether the second information is output. When the voice input is received, the preference information may be data for providing the second information based on the voice input, without confirming whether the second information is to be provided.

In step 750, the electronic device receives a third voice input through the microphone. The third voice input may include, for example, the same as (or similar to) the first voice input.

In step 760, when the first information is identified based on the third voice input, the electronic device outputs, through the speaker, a second signal corresponding to the identified first information. For example, when receiving the third voice input “Find a nearby restaurant” through the microphone, the electronic device may audibly output first information including the name of a restaurant located near the user (e.g., restaurant A) through the speaker.

In step 770, the electronic device determines whether a third signal corresponding to the second information is to be output based on the stored indication as to whether the second information is to be output. For example, when preference information stored in the memory includes positive preference data in relation to outputting the second information, the electronic device may output, through the speaker, the third signal corresponding to the second information, in response to the third voice input. As another example, when the preference information stored in the memory includes negative preference data in relation to outputting the second information, the electronic device may omit the output of the second information.

According to an embodiment, an electronic device includes a microphone; a speaker; a memory; and a processor configured to identify first information based on a first voice input received through the microphone, output a first signal for confirming whether second information related to the first information is output through the speaker, receive a second voice input related to whether the second information is output through the microphone, store whether the second information is output in the memory based on the second voice input, receive a third voice input through the microphone, output, when the first information is identified, a second signal corresponding to the first information through the speaker based on the third voice input, and determine whether a third signal corresponding to the second information is output based on whether the second information is output stored in the memory.

The processor may be configured to store a plurality of pieces of second information related to the first information in the memory; and select at least one piece of second information from the plurality of pieces of second information based on configuration information

The configuration information may include a designated condition with respect to the at least one piece of second information or a designated probability with respect to the at least one piece of second information.

The processor may be configured to output the first signal after receiving the third voice input without storing whether the second information is output in the memory, when the selection of the at least one piece of second information is omitted based on the designated condition or the designated probability.

The processor may be configured to apply a designated weight for selecting the at least one piece of second information based on whether the second information is output stored in the memory.

The processor may be configured to determine, when a second voice input related to whether the second information is output is not received through the microphone for a designated period of time after the output of the first signal, that the second voice input has been received.

The processor may be configured to generate the second information based on at least a portion of text data extracted from the first information.

When the first voice input is an input for performing a designated operation, the processor may be configured to generate the second information based on the first voice input.

The processor may be configured to omit the output of the first signal through the speaker based on whether the third signal is output, and output the third signal through the speaker.

The processor may be configured to update preference information related to whether the second information is output based on whether the second information is output stored in the memory.

According to an embodiment, a method for responding to a voice input includes: identifying first information based on a first voice input received through the microphone; outputting a first signal for confirming whether second information related to the first information is output through the speaker; receiving a second voice input related to whether the second information is output through the microphone; storing whether the second information is output in the memory based on the second voice input; receiving a third voice input through the microphone; outputting a second signal corresponding to the first information based on the third voice input when the first information is identified; and determining whether a third signal corresponding to the second information is output based on whether the second information is output stored in the memory.

The method may further include storing a plurality of pieces of second information related to the first information in the memory; and selecting at least one piece of second information from the plurality of pieces of second information based on the configuration information.

The configuration information may include a designated condition with respect to the at least one piece of second information or a designated probability with respect to the at least one piece of second information.

The method may further include outputting the first signal after receiving the third voice input without storing whether the second information is output in the memory, when the selection of the at least one piece of second information is omitted based on the designated condition or the designated probability.

The method may further include applying a designated weight for selecting the at least one piece of second information based on whether the second information is output stored in the memory.

The method may further include determining, when a second voice input related to whether the second information is output is not received through the microphone for a designated period of time after the output of the first signal, that the second voice input has been received.

The method may further include generating the second information based on at least a portion of text data extracted from the first information.

The method may further include generating the second information based on the first voice input when the first voice input is an input for performing a designated operation.

The method may further include omitting the output of the first signal through the speaker based on whether the third signal is output; and outputting the third signal through the speaker.

The method may further include updating preference information related to whether the second information is output based on whether the second information is output stored in the memory.

An electronic device according to an embodiment may be one of various types of electronic devices. The electronic device may include a portable communication device (e.g., a smartphone), a computer device, a portable multimedia device, a portable medical device, a camera, a wearable device, or a home appliance. However, an electronic device is not limited to those described above.

Various embodiments of the disclosure and the terms used therein are not intended to limit the technological features set forth herein to particular embodiments and include various changes, equivalents, or replacements for a corresponding embodiment.

A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). If an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

Herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter.

A machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to the above-described embodiments, a method for responding to a voice input and an electronic device supporting the same may provide additional information related to basic information according based on a user preference.

In addition, according to the above-described embodiments, a method for responding to a voice input and an electronic device supporting the same may determine whether to provide additional information related to basic information based on a user preference, so that an unnecessary operation of requesting an input related to whether to provide the additional information from the user may be omitted.

While the disclosure has been shown and described with reference to embodiments thereof, it will be apparent to those of ordinary skill in the art that various changes in form and details may be made therein without departing from the spirit and scope of the disclosure as defined by the appended claims and their equivalents.

What is claimed is:

1. An electronic device comprising:
a microphone;
a speaker;
a memory; and
a processor configured to:
identify first information based on a first voice input received through the microphone,
output, through the speaker, a first signal for confirming whether second information related to the first information is to be output,
receive, through the microphone, a second voice input related to whether the second information is to be output,
store, in the memory, an indication as to whether the second information is to be output, based on the second voice input,
receive a third voice input through the microphone,
output, through the speaker, when the first information is identified, a second signal corresponding to the first information, based on the third voice input, and
determine whether a third signal corresponding to the second information is to be output based on the stored indication as to whether the second information is to be output.

2. The electronic device of claim 1, wherein the processor is further configured to:
store, in the memory, a plurality of pieces of second information related to the first information, and
select at least one of the plurality of pieces of second information based on configuration information.

3. The electronic device of claim 2, wherein the configuration information includes a designated condition with respect to the at least of plurality of pieces of second information or a designated probability with respect to the at least one of the plurality of pieces of second information.

4. The electronic device of claim 3, wherein the processor is further configured to output the first signal, after receiving the third voice input, without storing another indication as to whether the second information is to be output in the memory, when the selection of the at least one of the plurality of pieces of second information is omitted based on the designated condition or the designated probability.

5. The electronic device of claim 2, wherein the processor is further configured to apply a designated weight for selecting the at least one of the plurality of pieces of second information based on the stored indication as to whether the second information is to be output.

6. The electronic device of claim 1, wherein the processor is further configured to determine, when the second voice input related to whether the second information is to be output is not received for a designated period of time, after the output of the first signal, that the second voice input has been received.

7. The electronic device of claim 1, wherein the processor is further configured to generate the second information based on at least a portion of text data extracted from the first information.

8. The electronic device of claim 1, wherein the processor further is configured to generate, when the first voice input is for performing a designated operation, the second information based on the first voice input.

9. The electronic device of claim 1, wherein the processor is further configured to:
omit the output of the first signal through the speaker based on whether the third signal is output, and
output the third signal through the speaker.

10. The electronic device of claim 1, wherein the processor is further configured to update preference information related to whether the second information is to be output based on the indication as to whether the second information is to be output.

11. A method performed by an electronic device, the method comprising:
identifying first information based on a first voice input received through a microphone;
outputting, through a speaker, a first signal for confirming whether second information related to the first information is to be output;
receiving, through the microphone, a second voice input related to whether the second information is to be output;
storing, in a memory, an indication as to whether the second information is to be output based on the second voice input;
receiving a third voice input through the microphone;
outputting, when the first information is identified, a second signal corresponding to the first information based on the third voice input; and
determining whether a third signal corresponding to the second information to be is output based on the stored indication as to whether the second information is to be output.

12. The method of claim 11, further comprising:
storing, in the memory, a plurality of pieces of second information related to the first information; and
selecting at least one of the plurality of pieces of second information based on configuration information.

13. The method of claim 12, wherein the configuration information includes a designated condition with respect to the at least one of the plurality of pieces of second information or a designated probability with respect to the at least one of the plurality of pieces of second information.

14. The method of claim 13, further comprising:
outputting the first signal, after receiving the third voice input, without storing, in the memory, another indication as to whether the second information is to be output, when the selection of the at least one of the plurality of pieces of second information is omitted based on the designated condition or the designated probability.

15. The method of claim 12, further comprising applying a designated weight for selecting the at least one of the plurality of pieces of second information based on the stored indication as to whether the second information is output.

16. The method of claim 11, further comprising determining, when the second voice input related to whether the second information is to be output is not received through the microphone for a designated period of time after outputting the first signal, that the second voice input has been received.

17. The method of claim 11, further comprising generating the second information based on at least a portion of text data extracted from the first information.

18. The method of claim 11, further comprising generating the second information based on the first voice input, when the first voice input is for performing a designated operation.

19. The method of claim 11, further comprising:
omitting outputting the first signal through the speaker based on whether the third signal is to be output; and
outputting the third signal through the speaker.

20. The method of claim 11, further comprising updating preference information related to whether the second information is to be output based on the stored indication as to whether the second information is to be output.
